(19) United States
(12) Patent Application Publication
(10) Pub. No.: US 2012/0194196 A1
(43) Pub. Date: Aug. 2, 2012

(54) Electromagnetic Source to Produce Multiple Electromagnetic Components

(76) Inventors: Leendert Combee, Sandvika (NO); Andrea Zerilli, Fiorenzuola d' Arda (PC) (IT)

(21) Appl. No.: 13/019,599

(22) Filed: Feb. 2, 2011

(51) Int. Cl. G01V 3/00

(52) U.S. Cl. 324/365

(57) ABSTRACT

An electromagnetic (EM) source assembly for performing marine subterranean surveying includes electrodes in an arrangement configured for towing through a body of water. A controller is configured to selectively activate different sets of the plurality of electrodes, where a first of the sets produces an EM field in a first direction, and where a second of the sets produces an EM field in a second, different direction.

### BACKGROUND

Electromagnetic (EM) techniques can be used to perform surveys of subterranean structures for identifying zones of interest. Examples of zones of interest in a subterranean structure include hydrocarbon-bearing reservoirs, gas injection zones, gas hydrates, thin carbonate or salt layers, and fresh-water aquifers.

One type of EM survey technique is the controlled source electromagnetic (CSEM) survey technique, in which an EM transmitter, called a “source,” is used to generate EM signals. Surveying units, called “receivers,” are deployed within an area of interest to make measurements from which information about the subterranean structure can be derived. The EM receivers may include a number of sensing elements for detecting any combination of electric fields, electric currents, and/or magnetic fields.

Traditionally, an EM source is implemented with two electrodes, one mounted on the front and one mounted on the aft of an antenna. The two electrodes of the EM source are connected to the “+” and “−” terminals of a power source system. However, this traditional arrangement of an EM source does not provide flexibility, particularly in marine survey applications.

### SUMMARY

In general, according to some embodiments, an electromagnetic (EM) source assembly for performing marine subterranean surveying includes a plurality of electrodes in an arrangement configured for towing through a body of water. A controller selectively activates different sets of the plurality of electrodes, where the first set produces an EM field in a first direction, and where a second set produces an EM field in a second, different direction.

Other or alternative features will become apparent from the following description, from the drawings, and from the claims.

### BRIEF DESCRIPTION OF THE DRAWINGS

Some embodiments are described with respect to the following figures:

FIG. 1 is a schematic diagram of an arrangement for performing a marine survey, according to some embodiments;

FIGS. 2 and 3 illustrate electric dipoles produced by electrodes in an electromagnetic (EM) source assembly according to some embodiments;

FIGS. 4A-4B are schematic diagrams of another arrangement for performing a marine survey, according to further embodiments;

FIGS. 5 and 6 illustrate electric dipoles produced by electrodes in an EM source assembly according to further embodiments;

FIG. 7 is a timing diagram of waveforms for activating different sets of electrodes in an EM source assembly according to some embodiments; and

FIG. 8 is a schematic diagram of another (vertical in this example) EM source arrangement, according to some embodiments.

### DETAILED DESCRIPTION

Electromagnetic (EM) fields used for determining properties of subterranean structures typically have two fundamental field quantities: an electric field E and a magnetic field H. Each of electric field E and magnetic field H is a vector field, in that they have a magnitude and a direction in three-dimensional (3D) space. Both magnitude and direction vary depending on the point of observation (at the EM receiver), the subterranean structure and its electrical properties, time, and characteristics of the EM source.

In many applications, an EM source is configured as an electrical dipole, formed of two electrodes that are spaced apart. An electrical current is injected by these electrodes into the surrounding body of water and into a subterranean structure. The generated EM field (as affected by the subterranean structure) is then sensed by EM receivers distributed or towed over a water bottom surface (e.g., seafloor).

The electric dipole source is a vector source of a given strength and direction. The given strength is based on the dipole moment, which is the current injected into the surrounding medium multiplied by the distance between the electrodes. The direction is represented as the vector from one of the electrodes to another of the electrodes.

The vector nature of the EM source allows for various orientations of the source. A vertical electrical dipole (VED) source orientation is able to generate a magnetic field having a vector orientation in the horizontal plane, which is parallel to the dominant structural boundaries in the subterranean structure. An EM field produced by a VED source is referred to as a transverse magnetic (TM) field, which is most sensitive to thin, high-resistivity zones (e.g., hydrocarbon bearing zones) in the subterranean structure. Another source orientation is the horizontal electric dipole (HED) source orientation, which produces a combination of TM and transverse electric (TE) fields. A TE EM field is generally parallel to the dominant structural boundaries in the subterranean structure, and is marginally sensitive to resistive zones in the subterranean structure.

Typically, to obtain subterranean measurements that are responsive to EM fields of different orientations, a survey operator may perform towing of the survey arrangement in multiple directions. However, having to perform towing in different directions is time consuming and can be expensive. Moreover, variations in position and time and/or environment can mean that the response to the multi-directional data may not be exactly co-located in time and space and thus can be subjected to considerable measurement noise.

In accordance with some embodiments, an EM source assembly is controllable to produce EM fields in multiple directions to improve efficiency of EM subterranean surveying. In some embodiments, the EM source assembly has multiple electrodes and a controller to selectively activate different sets of the multiple electrodes. A first of the sets produces an EM field in a first direction, and a second of the sets produces an EM field in a second, different direction. The first and second sets can share at least one electrode. In some implementations, different waveforms are provided to the electrodes in the first and second sets to produce the EM fields in the different directions. Also, in some implementations, at least one electrode active in the first set is inactive in the second set. In some implementations, at least one electrode that is active in the first set can be inactive when the second set is activated.

In alternative implementations, all electrodes in the multiple sets can be driven with waveforms at all times—however, different waveforms are provided at different times to cause production of EM fields in the different directions by the same EM source assembly.

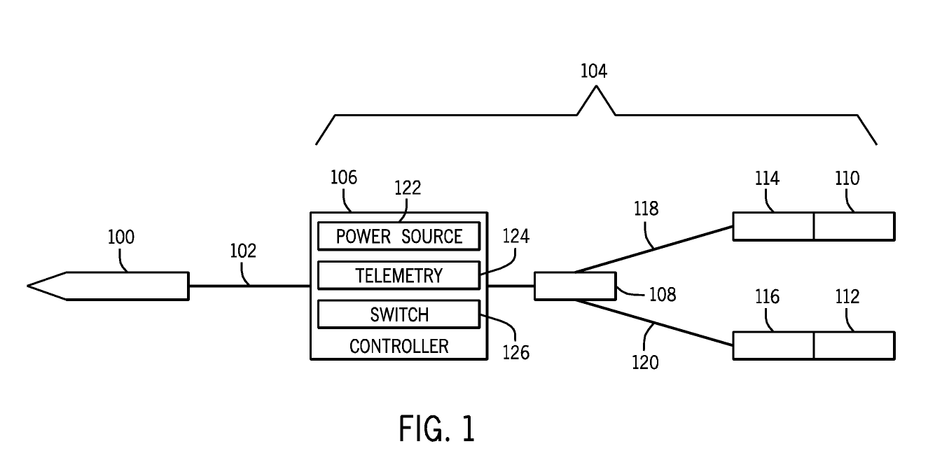

An example of a survey arrangement according to some embodiments is depicted in FIG. 1, which is a top (bird's eye) view of the survey arrangement. A marine vessel 100 tows, on a tow cable 102, an EM source assembly 104. The EM source assembly 104 has a controller 106 and multiple electrodes 108, 110, and 112. The electrodes 110 and 112 are associated with a respective deflectors 114 and 116 to maintain the relative positions of the electrodes 110 and 112. Although just three electrodes are shown as being part of the EM source assembly 104, it is noted that additional electrodes can be provided in the EM source assembly 104.

The deflectors 114 and 116 can either be passive deflectors (e.g., wings) or active deflectors (e.g., propeller driven devices). An active deflector typically includes one or more propellers to control depth, azimuth, and direction of a deflection. An antenna cable 118 is connected between the electrode 108 and the deflector 114, and an antenna cable 120 is connected between the electrode 108 and deflector 116. The deflectors 114 and 116 are able to maintain the relative spacings among the electrodes 108, 110, and 112, in both the x direction and y direction, where the x direction is an in-line direction (direction of marine vessel 100 movement), and the y direction is a cross-line direction generally perpendicular to the in-line direction (x). In some cases, the deflectors can maintain a relatively symmetric antenna arrangement.

If the deflectors 114 and 116 are active deflectors, such active deflectors can receive their power over the antenna cables 118 and 120. In some implementations, the deflectors 118 and 120 can be equipped with positioning beacons such that their positions can be monitored and controlled in real-time (i.e., as the subterranean surveying is being performed).

As further depicted in FIG. 1, the controller 106 includes a power source 122 (to provide power to the electrodes 108, 110, and 112 and to the deflectors 114 and 116). In some implementations, the power source 122 can include a converter to convert from high-voltage input power (such as from the marine vessel 100) to a low-voltage, high-current output power. In addition, the controller 106 includes a telemetry subsystem 124 (to allow for communications between the marine vessel 100 and the electrodes and deflectors in the EM source assembly 104).

The controller 106 also includes a switch subsystem 126 that is able to selectively activate different sets of the electrodes 108, 110, and 112 at different times. The switching between the different sets of electrodes can be controlled at the controller 106, or can be in response to commands sent from a controller at the marine vessel 100.

The electrodes 108, 110, and 112 inject switched electrical currents into the surrounding body of water. In some implementations, a first set of the electrodes that are selectively activated by the switch subsystem 126 includes all three electrodes 108, 110, and 112. A second, different set of electrodes that are selectively activated by the switch subsystem 126 includes just electrodes 110 and 112.

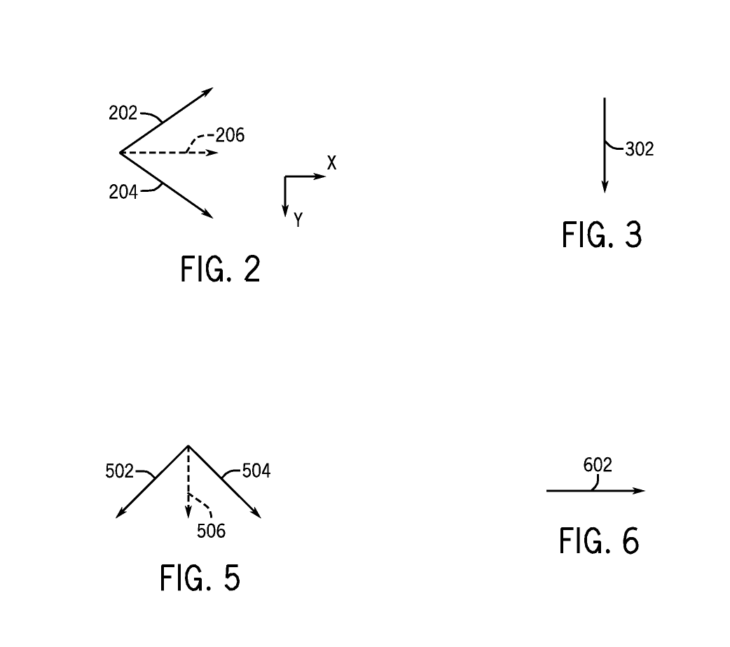

When the first set of electrodes (108, 110, and 112) is activated, then two electric dipoles are produced, as depicted in FIG. 2, which shows a first electric dipole 202 between the electrode 108 and electrode 110, and a second electric dipole 204 between the electrode 108 and electrode 112. A vector sum of the electric dipoles 202 and 204 produces a resulting dipole 206 (represented by a dashed arrow in FIG. 2) that is generally along the x direction. The first set of electrodes (108, 110, 112) produces a mixed-mode EM field including transverse magnetic (TM) EM field and transverse electric (TE) EM field, which is produced by an effective in-line towed source antenna.

The second, different set of electrodes (110 and 112) when activated produces an electric dipole 302 generally in the y direction, as shown in FIG. 3. In the FIG. 3 arrangement, the second set of electrodes (110, 112) produces a TE mode EM field. With the FIG. 3 arrangement, no current passes through the electrode 108.

In each of FIGS. 2 and 3, the electric dipoles 202, 204, 206, and 302 are shown as pointing in particular directions—note, however, that the electric dipoles can point in the opposite directions, depending upon the relative magnitudes of the voltages of the corresponding pairs of electrodes.

Using implementations according to some embodiments, two vector sources are provided by the same EM source assembly. This allows for joint collocated acquisition of both the TE and TM modes during an EM subterranean survey, which improves interpretation of data while allowing for acquisition in both modes in a more efficient manner than conventionally performed. Also, the EM source assembly 104 does not have to be towed by the marine vessel 100 in multiple different directions to perform acquisition in the TE and TM modes. In fact, the arrangement according to some embodiments allows for the EM source assembly 104 to be towed in just one direction, while allowing for acquisition in both the TE and TM modes.

Also, note that with the EM source assembly 104 shown in FIG. 1, the EM source assembly 104 can be towed in a relatively practical manner. Drag forces of the EM source assembly 104 are relatively manageable, such that excessive deformation would not be present in the antenna cables 118 and 120.

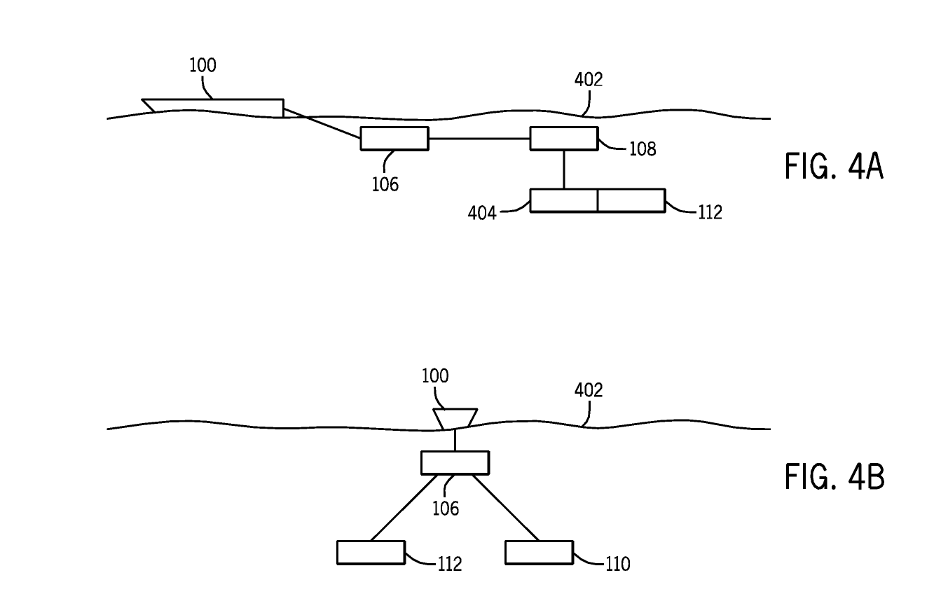

FIGS. 4A-4B illustrates an alternative arrangement. In the FIG. 1 arrangement, the electrodes 108, 110, and 112 are generally in a horizontal plane that is parallel to a seafloor (the electrodes in FIG. 1 are generally at the same depth, to within predefined tolerances caused by water motion). In the alternative arrangement depicted in FIGS. 4A-4B, the electrodes are vertically arranged (where the electrode 108 is at a depth different from the depths of electrodes 110 and 112). FIG. 4A is a side view, which shows the controller 106 and common electrode 108 provided near a water surface 402. However, the electrode 112 is spaced apart vertically from the electrode 108, where this vertical spacing can be maintained by a deflector 404.

FIG. 4B is a rear view of the arrangement of FIG. 4A, which shows the common electrode 108 and electrodes 112 and 110 that are vertically spaced apart from the common electrode 108. The electrode 110 is similarly maintained in the vertically spaced apart arrangement by a corresponding deflector (not shown) similar to the deflector 404.

In the arrangement of FIGS. 4A-4B, a first set of electrodes that is activated can include electrodes 108, 110, and 112, which produces electric dipoles 502 and 504 depicted in FIG. 5. The vector sum of the electric dipoles 502 and 504 produces a resultant dipole 506 that extends generally in the vertical direction.

The second set of electrodes that is activated at a different time by the controller 106 can include electrodes 110 and 112, which produce an electric dipole 602 in the direction depicted generally in FIG. 6. The direction of electric dipole 602 is generally parallel to the y direction.

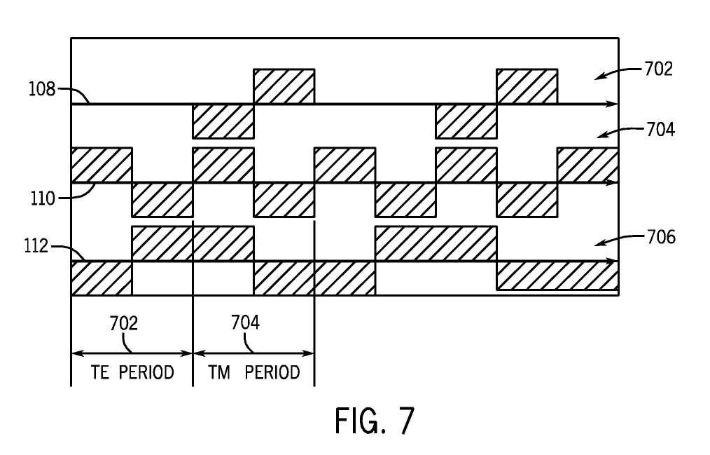

FIG. 7 shows an example of electrical current waveforms that can be provided to respective electrodes 108, 110, and 112, in either the FIG. 1 arrangement or FIGS. 4A-4B arrangement. Each of the waveforms shown in FIG. 7 are square waveforms. In alternative implementations, other types of waveforms can be used. As shown in the example of FIG. 7, in a first time period 702, a TE mode EM field is produced, while in a second time period 704, a TM mode EM field is produced. The pattern of producing TE mode EM fields and TM mode EM fields is repeated over time during the subterranean survey.

In FIG. 7, a first waveform 702 drives electrode 108, a second waveform 704 drives electrode 110, and a third waveform 706 drives electrode 112. When just electrodes 110 and 112 are activated in the TE period 702, the polarities of the waveforms 704 and 706 at any given time are opposite to each other. In contrast, in the TM period 704, the polarities of the waveforms 704, 706 driving electrodes 110 and 112 are the same at any given time. However, in the TM period 704, the polarity of the waveforms 704 and 706 is opposite the polarity of the waveform 702 driving electrode 108 at any given time.

The waveform 704 in TE period is considered to be different from the waveform 704 in the TM period. Similarly, the waveform 706 in the TE period is considered to be different from the waveform 706 in the TM period. Note that other switching schemes can be used, such as where the polarities of the waveforms 704 and 706 are alternated for successive TE periods. This can create a more even loading pattern for electrodes 110 and 112 in the TE periods.

It is also possible to duplicate electrode 108 and use two separate electrodes, with the same TM mode or opposite TM mode polarities. In that case, all electrodes are active at any time and possible corrosion effects are balanced.

The FIG. 7 switching scheme alternates a TE period with a TM period, such that each TE period is followed by a TM period and vice versa. In alternative implementations, multiple TE periods are successively provided in a first time slice, and multiple TM periods are successively provided in a next time slice.

The EM source assembly shown in either FIG. 1 or FIGS. 4A-4B is considered a cross-dipole source, since the EM source assembly is able to produce electric dipoles in different directions. Such a cross-dipole source can also be combined with a vertical source arrangement. In this latter approach, one or more additional electrodes can be placed along the tow cable and can be energized whenever the cross-dipole source is in the TM mode. In this way, the EM source assembly can be focused towards the vertical and become a near-perfect TM source.

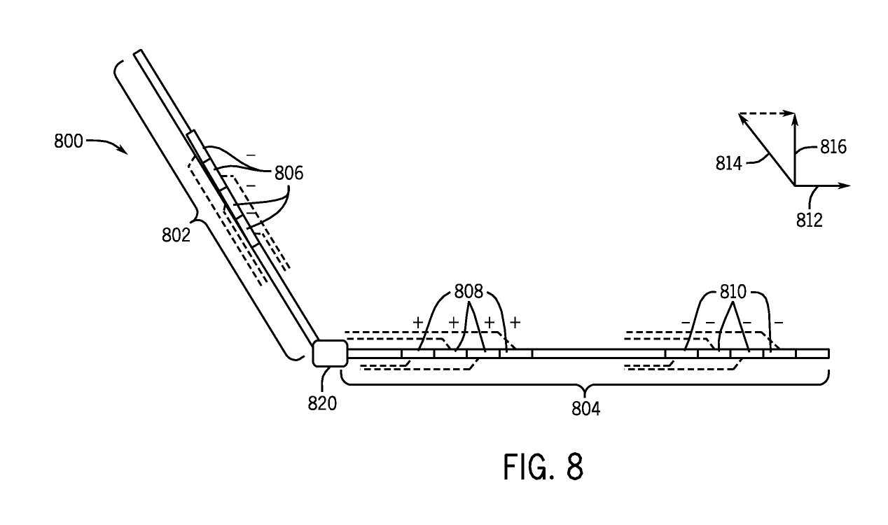

An example of the vertical source arrangement is depicted in FIG. 8. Note, however, that in other implementations, other vertical source arrangements can be used.

The vertical source arrangement 800 of FIG. 8 has multiple antenna sections 802 and 804, which are angled with respect to each other. Although just two antenna sections are shown in FIG. 8, it is noted that additional antenna sections can be provided in other implementations.

The antenna section 802 has a first set of electrodes 806, and the antenna section 804 has a second set of electrodes 808 and a third set of electrodes 810. Each of the electrodes 806, 808, and 810 is connected by a corresponding wire (represented by the dashed lines in FIG. 8 to a controller 820, which can be the controller 106 of FIG. 1).

In the example arrangement of FIG. 8, it is assumed that one of the electrodes 808 is connected to a positive voltage, while one of the electrodes 806 and one of the electrodes 810 are connected to a negative voltage. As a result, an electrical dipole 812 is developed between the activated electrode 808 and the activated electrode 810, while another electric dipole 814 is established between the activated electrode 808 and the activated electrode 806. Note that the dipole 812 is generally in the horizontal direction, while the dipole 814 is in the diagonal direction.

Because of the presence of dipoles 812 and 814 in different directions, an effective dipole 816 that is a summation of the dipoles 812 and 814 is developed. Note that in the example of FIG. 8, the effective dipole 816 extends in a vertical direction. By activating more or less electrodes in the antenna sections 802 and 804, the precise radiation pattern (vector sum) can be tuned.

By using the arrangement of FIG. 8, an effective vertical source can be provided, which can also be towed by a marine vessel in a marine survey arrangement. Typically, a vertical source cannot be towed.

Although reference is made to activating just one electrode in each of the three sets of electrodes shown in FIG. 8, it is noted that is also possible to activate more than one electrode in each of the sets of electrodes.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. An electromagnetic (EM) source assembly for performing marine subterranean surveying, comprising:
a plurality of electrodes in an arrangement configured for towing through a body of water; and
a controller configured to selectively activate different sets of the plurality of electrodes, wherein a first of the sets produces an EM field in a first direction, and wherein a second of the sets produces an EM field in a second, different direction, and wherein the first and second sets share at least one electrode.

2. The EM source assembly of claim 1, wherein the first direction is an in-line direction, and the second direction is an in-line direction.

3. The EM source assembly of claim 1, wherein the first direction is a vertical direction, and the second direction is a cross-line direction.

4. The EM source assembly of claim 1, wherein the controller is configured to drive waveforms to the first and second sets to produce the EM fields in the first and second directions.

5. The EM source assembly of claim 4, wherein each of the waveforms includes a series of positive and negative pulses.

6. The EM source assembly of claim 4, wherein the controller is configured to:
drive a first waveform to the first set during a first time period; and
drive a second waveform to the second set during a second time period.

7. The EM source assembly of claim 1, wherein the EM field in the first direction is one of a transverse magnetic (TM) EM field and a transverse electric (TE) EM field, and the EM field in the second direction is another of the TM EM field and TE EM field.

8. The EM source assembly of claim 1, further comprising a vertical source to generate an EM field in a vertical direction.

9. The EM source assembly of claim 8, wherein the first direction is an in-line direction, and the second direction is a cross-line direction.

10. A method of performing an electromagnetic (EM) survey, comprising:
towing an EM source assembly through a body of water, wherein the EM source assembly has plural electrodes;
activating different sets of the plural electrodes to produce EM fields in multiple directions, wherein the different sets share at least one electrode; and
measuring the EM fields as affected by a subterranean structure by at least one EM receiver.

11. The method of claim 10, wherein producing the EM fields in the multiple directions comprises producing an EM field in an in-line direction and an EM field in a cross-line direction.

12. The method of claim 10, wherein producing the EM fields in the multiple directions comprises producing an EM field in a vertical direction and an EM field in an in-line direction.

13. The method of claim 10, wherein activating the different sets comprises activating a first of the sets to produce a transverse magnetic (TM) EM field, and activating a second of the sets to produce a transverse electric (TE) EM field.

14. The method of claim 13, wherein the TM EM field is produced during a first time period, and the TE EM field is produced during a second time period different from the first time period.

15. The method of claim 14, wherein a first group of waveforms is used to drive respective electrodes in the first set during the first time period, and a second, different group of waveforms is used to drive respective electrodes in the second set during the second time period.

16. The method of claim 10, wherein the first set includes a first electrode and second electrodes spaced apart in a cross-line direction, and wherein the second set includes the second electrodes but not the first electrode.

17. The method of claim 16, wherein the first electrode and second electrodes are generally at a same depth.

18. The method of claim 16, wherein the first electrode is at a different depth than the second electrodes.

19. A system comprising:
a marine vessel; and
an electromagnetic (EM) source assembly towed by the marine vessel for performing marine subterranean surveying, the EM source assembly comprising:
a plurality of electrodes; and
a controller configured to selectively activate different sets of the plurality of electrodes, wherein a first of the sets produces an EM field in a first direction, and wherein a second of the sets produces an EM field in a second, different direction, and wherein the first and second sets share at least one electrode.
